(19) United States
(12) Patent Application Publication
(10) Pub. No.: US 2011/0191457 A1
(43) Pub. Date: Aug. 4, 2011

(54) FOOTPRINT REDUCTION FOR A MANUFACTURING FACILITY MANAGEMENT SYSTEM

(75) Inventors: Amudhasagaran Nadesan, Fremont, CA (US); Philip Kurjan, Sunnyvale, CA (US)

(73) Assignee: APPLIED MATERIALS, INC., Santa Clara, CA (US)

(21) Appl. No.: 13/019,880

(22) Filed: Feb. 2, 2011

Related U.S. Application Data
(60) Provisional application No. 61/300,776, filed on Feb. 2, 2010.

(51) Int. Cl. G06F 15/173

(52) U.S. Cl. 709/223

(57) ABSTRACT

A facility management system includes a combined server providing both event services and application server functionality. The combined server receives a communication request from a client and determines if the received request corresponds to an asynchronous or a synchronous communication. If the received request corresponds to an asynchronous communication, the combined server creates a task corresponding to the communication request. The combined server determines whether to execute the task locally on the combined server or on a remote combined server, and if the task is to be executed locally, executes the task.

### RELATED APPLICATIONS

This application claims the benefit of U.S. Provisional Application No. 61/300,776 filed on Feb. 2, 2010.

### TECHNICAL FIELD

Embodiments of the present invention relate generally to computer systems for managing a manufacturing facility, and more particularly to reducing a footprint of a manufacturing facility management system.

### BACKGROUND

Typically, a manufacturing facility is managed using multiple servers. The facility can be used to manufacture semiconductors, solar devices, display devices, batteries, etc. In particular, various client computers in a manufacturing facility, such as systems that move lots from one part of the facility to another, manufacturing tools configured to report information about themselves, user operated machines, etc., send numerous requests to a set of application servers. Because of the high traffic in the manufacturing facility, these application servers can become unevenly loaded when traditional load balancing software is used. One conventional solution for providing load balancing in a manufacturing facility is illustrated in FIGS. 1A and 1B.

FIG. 1A illustrates a network architecture 100 of a known method for managing a manufacturing facility. Network architecture 100 can include a client 101, an event services server 107, and application servers 113, 115, and 117.

Client 101 contains a load balancer 103, an interceptor layer 105, and a shared memory 141. Generally, client 101 sends requests over the network 119 to the application servers 113, 115, and 117 for execution.

Event services server 107 contains a load balancer 109, an interceptor layer 111, and a shared memory 141. Event services server 107 runs the highly available services that are needed to handle the asynchronous communication within the manufacturing facility. Communications that are asynchronous are created by a client such as client 101 and then placed in a serial message queue to be handled by the event services server 107. Event services server 107 receives these asynchronous communication requests and converts them into tasks to be executed by the application servers 113, 115, and 117.

Application servers 113, 115, and 117 contain a shared memory 141. Application servers 113, 115, and 117 track the manufacturing process and collect and maintain data regarding the facility, as well as execute requests made by client 101 and event services server 107.

When client 101 or event services server 107 sends a request to be executed by an application server, a decision is made as to which of the application servers 113, 115, and 117 should execute the request. In order to more evenly distribute the workload between application servers, shared memory 141 is populated on client 101, event services server 107, and application servers 113, 115, and 117. A service running on client 101 and event services server 107 updates the shared memory 141 with information regarding the availability and workload of application servers 113, 115, and 117. This information can be propagated among the various machines by use of Microsoft® Windows® Peer-to-Peer Networking such that each application server 113, 115, and 117 communicates with both client 101 and event services server 107 as pictured. Interceptor layer 105 or 111 intercepts any request to be sent to an application server for execution made by client 101 or event services server 107. The interceptor layer communicates with load balancer 103 or 109, which determines which of the application servers 113, 115, and 117 is best suited to execute the request. Load balancer 103 or 109 makes this determination based on information obtained from shared memory 141. The determination is based on which application server is least lightly loaded. This can be determined based on the number of calls executing on each of the application servers at the time the request is made. Information about the number of calls is available in shared memory 141, and the request can be routed to whichever application server has the fewest number of calls executing. Once the determination is made by load balancer 103 or 109, interceptor layer 105 or 111 sends the request to the appropriate server. This ensures that the workload is more evenly distributed between application servers 113, 115, and 117.

FIG. 1B illustrates the processing of a typical communication request issued by a client 121 or 131 for execution by application server 123 or 129. If the client request is an asynchronous communication request, such as a create job request issued by client 121, the request must be processed by the event services server 125 before it can be executed by one of the application servers 123 or 129. Initially, a create job request is made by the client 121 to be communicated to an application server. The request is load balanced to the least lightly loaded application server 123 or 129 (step 1A) as described above in conjunction with FIG. 1A. The create job request is then published (step 2A) by being sent by application server 123 to event services server 125. The client 121 is notified (step 3A) by application server 123 that the create job request has been completed. Event services running on event services server 123 convert the create job message received from application server 123 into an execute task call, and the execute task call is load balanced to application server 123 or 129 (step 4A) as described above in conjunction with FIG. 1A. When the task is executed by application server 123 or 129, the event services server 125 is notified that the desired job has been executed (step 5A).

If the client request is not an asynchronous communication request, the client 131 issues the request (e.g., an execute script call). The request is load balanced to application server 123 or 129 (step 1B) as described above in conjunction with FIG. 1A. The application server executes the requested script and returns a message to the client once the task has been executed (step 2B).

Similar problems exist in areas such as distributed database management. In a common distributed database management solution, databases optimize themselves by moving portions of the database among different nodes to the locations where there is the strongest incidence of queries associated with those portions. However, the solution in the manufacturing facility context differs significantly from the distributed database management context. Distributed database query load balancing does not measure the load on each database server, send that information to each client, and then allow each client to intelligently select the target database based on the load, as is done in the manufacturing facility context. Furthermore, in a distributed database query load balancing system, each node generally has a different function (e.g., contains a different portion of the database and responds to different queries), whereas each application server in a manufacturing facility is identical and therefore a client request can be sent to whichever application server is least lightly loaded.

In a typical manufacturing facility, the event services need to be handled by a Microsoft Windows Cluster Service cluster of two servers because of a need for high availability. However, these servers are often very lightly loaded as compared to the application servers, even after effective load balancing. What is needed is a way to more efficiently utilize the server capabilities of the event service servers.

### BRIEF DESCRIPTION OF THE DRAWINGS

The present invention is illustrated by way of example, and not by way of limitation, in the figures of the accompanying drawings and in which:

FIG. 1A illustrates a network architecture in which a prior art method for managing a semiconductor manufacturing facility is implemented;

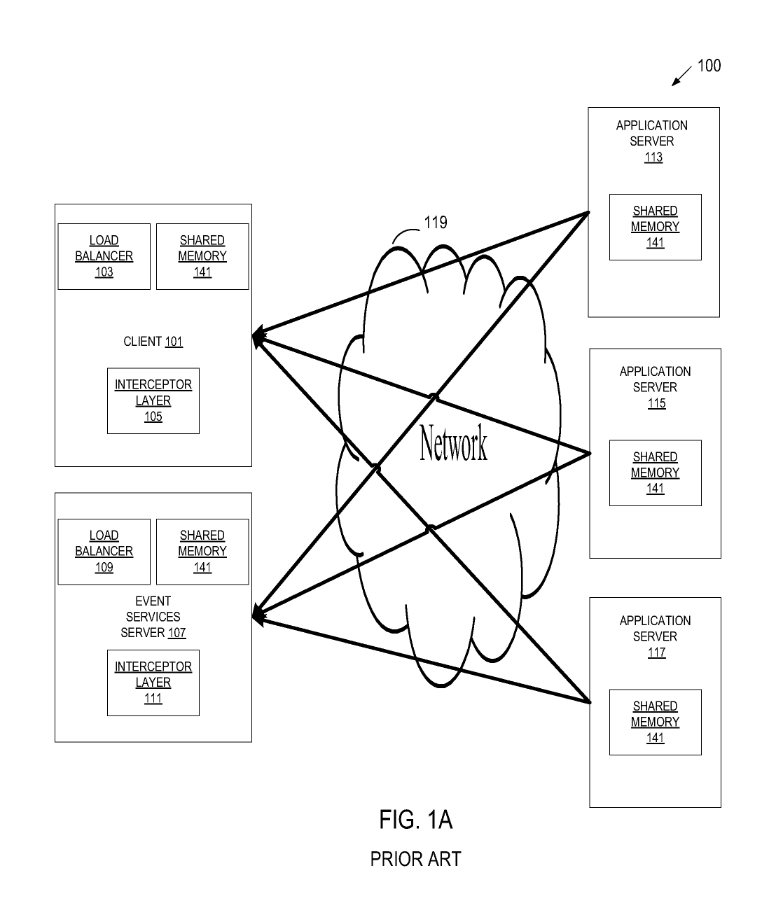

FIG. 1B illustrates a prior art method for handling a communication request in a semiconductor manufacturing facility;

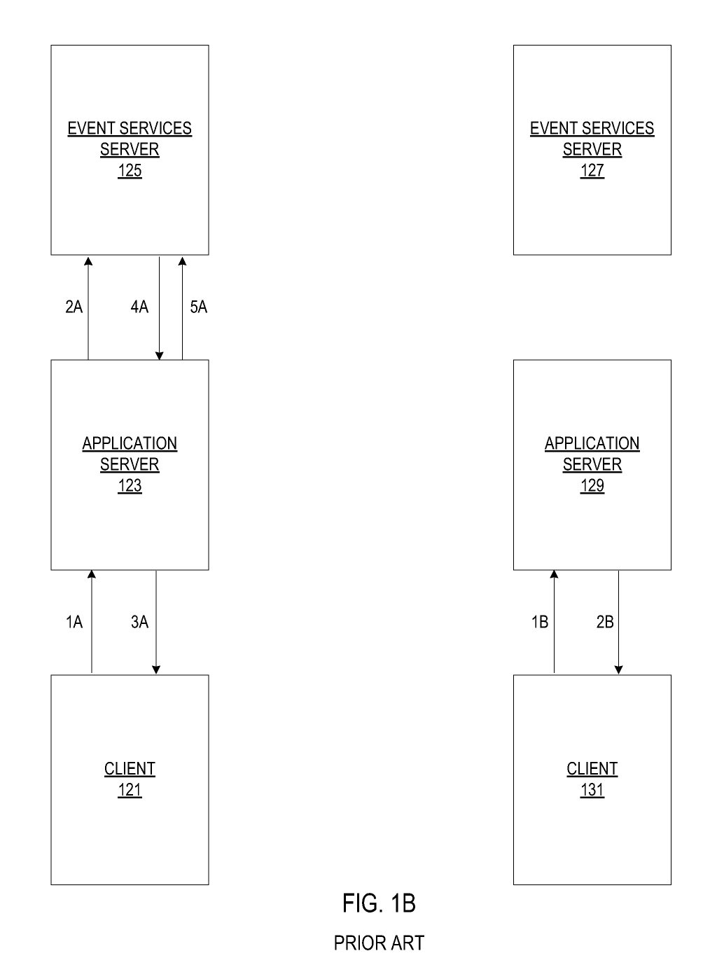

FIG. 2 illustrates a network architecture in which embodiments of the present invention may be implemented;

FIG. 3 illustrates the processing of a communication request in a semiconductor manufacturing facility according to some embodiments of the invention;

FIG. 4 illustrates one embodiment of a method for processing a request by a combined server having application server and event services functionality; and

FIG. 5 illustrates an exemplary computer system providing functionality of a combined server.

### DETAILED DESCRIPTION

Described herein is a method and system for managing a manufacturing facility. The facility may be used to manufacture semiconductor devices, solar devices, display devices, batteries, or any other device or item. In one embodiment, the system may include two clustered, single server computers that each host a business logic module to provide application server functionality and an event services module to provide event services.

Embodiments of the present invention provide an efficient mechanism for managing a semiconductor manufacturing facility. By integrating event services and application server functionality into a single server, the inefficiency inherent in running event services on separate, highly available, lightly loaded servers is eliminated. The footprint required to manage a manufacturing facility is reduced while an even distribution of workload between the servers within the facility is maintained.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

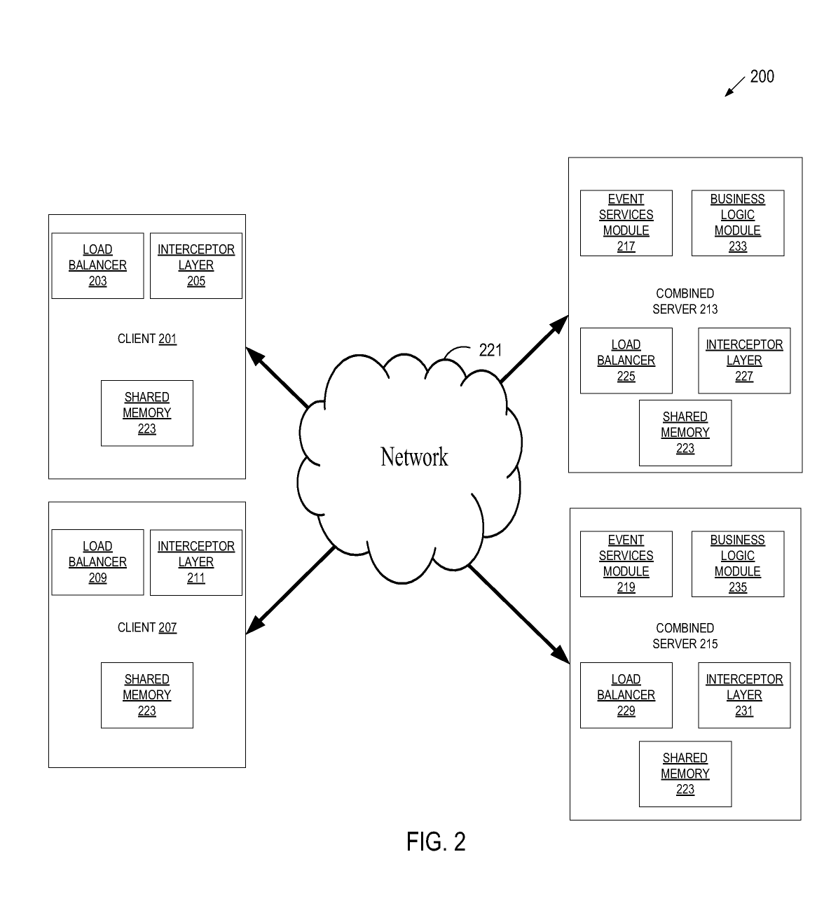

FIG. 2 illustrates a network architecture in which embodiments of the present invention may be implemented. System 200 can include clients 201 and 207 and combined servers 213 and 215. Clients 201 and 207 can be coupled to combined servers 213 and 215 via a network 221, such as a private network (e.g., a local area network (LAN)) or a public network (e.g., the Internet).

Clients 201 and 207 can be external systems such as ones that move lots from one part of the facility to another, manufacturing tools configured to report information about themselves, user operated machines, etc. Clients 201 and 207 may contain load balancers 203 and 209, interceptor layers 205 and 211, and a shared memory 223. Load balancers 203 and 209, and interceptor layers 205 and 211 may be implemented in software, hardware, or a combination of hardware and software. Clients 201 and 207 may send requests over the network 221 to the combined servers 213 and 215.

Combined servers 213 and 215 may contain event services modules 217 and 219, business logic modules 233 and 235, load balancers 225 and 229, interception layers 227 and 231, and shared memory 223. Event services modules 217 and 219, business logic modules 233 and 235, load balancers 225 and 229, and interception layers 227 and 231 may be implemented in software, hardware, or a combination of hardware and software. Event services modules 217 and 219 may run the highly available services that are needed to handle asynchronous communication within the manufacturing facility and which were previously handled by a separate event services server cluster. Asynchronous communications within the manufacturing facility can be requests for changing the states of tools at a certain time in order to perform preventative maintenance, client requests that are to be executed concurrently by the application servers (e.g., a request to create a lot for processing and then to track the processing of the lot at a future time) such that a client cannot wait for one request to be executed before creating a next request, etc. Exemplary services residing in the event service modules may include: the event service server, which handles the dispatching of messages; a PDController (Process Director Controller), which converts messages into executables tasks and forwards them to the least loaded application server (e.g., a task execution controller); and a TimerManager, which manages timer related tasks and scheduled activities like preventive maintenance. In the illustrated embodiment, there are two combined servers 213, 215 in system 200, however it should be understood that in other embodiments there may be any number of combined servers. In one embodiment, only combined servers 213, 215 may include event services modules 217 and 219 while the additional servers function as “application servers,” however in other embodiments, all servers in system 200 may be “combined servers” providing event services functionality.

Business logic modules 233 and 235 may track the manufacturing process and collect and maintain data regarding the facility, as well as execute requests made by clients 201 and 207 and event services modules 217 and 219. Combined servers 213 and 215 therefore offer the same functionality as a separate application and event services servers while eliminating the inefficiency inherent in operating separate, highly available, lightly utilized event service servers.

In one embodiment, in order to more evenly distribute the workload between the combined servers, load balancing is performed not only for requests sent by clients 201 and 207 to the combined servers, but also for requests made by the event services modules 217 and 219. To accomplish this, shared memory 223 is populated on clients 201 and 207 and combined servers 213 and 215. A service running on clients 201 and 207 and combined servers 213 and 215 updates the shared memory 223 with information regarding the availability and workload of combined servers 213 and 215. This information can be propagated among the various machines by use of peer-to-peer communication software, such that each of the combined servers 213 and 215 communicates with each of the clients 201 and 207, as well as with each other, as shown in FIG. 2.

When a request is made by a client 201 or 207 or event services modules 217 or 219, interceptor layer 205, 211, 227 or 231 may intercept any requests that are to be sent to a business logic module (e.g., business logic module 233 or 235) for execution. The interceptor layer communicates with load balancer 205, 211, 225, or 229, which determine which of the combined servers 213 and 215 is best suited to execute the request. The load balancer may make this determination based on information obtained from shared memory 223. In one embodiment, the determination is made based on which of combined servers 213 and 215 is least lightly loaded. This can be determined based on the number of calls executing on each of the combined servers at the time the request is made. Information regarding the number of calls may be available in shared memory 223, and the request can be routed to whichever combined server has the fewest number of calls currently executing. In an alternative embodiment, the determination is made based in part on the number of calls executing on each server and in part on a least loaded and round robin distribution for more effective load balancing.

Once the determination is made by the load balancer, the interceptor layer sends the request to the appropriate server. If the request originated from an event services module (e.g., event services module 217 or 219) and the appropriate server is determined to be the combined server on which the event services module resides, the interceptor layer readies the request for execution locally. For example, if a request is made by event services module 217, interceptor layer 227 may intercept the request. Load balancer 225, in conjunction with shared memory 223, may determine which of combined servers 213 or 215 is best suited to execute the request. If it is determined that combined server 215 is least lightly loaded, the interceptor layer sends the request to combined server 215 for execution. Alternatively, if combined server 213 is least lightly loaded, interceptor layer 227 keeps the request for local execution by business logic 233. This approach ensures that the workload is more evenly distributed between combined servers 213 and 215.

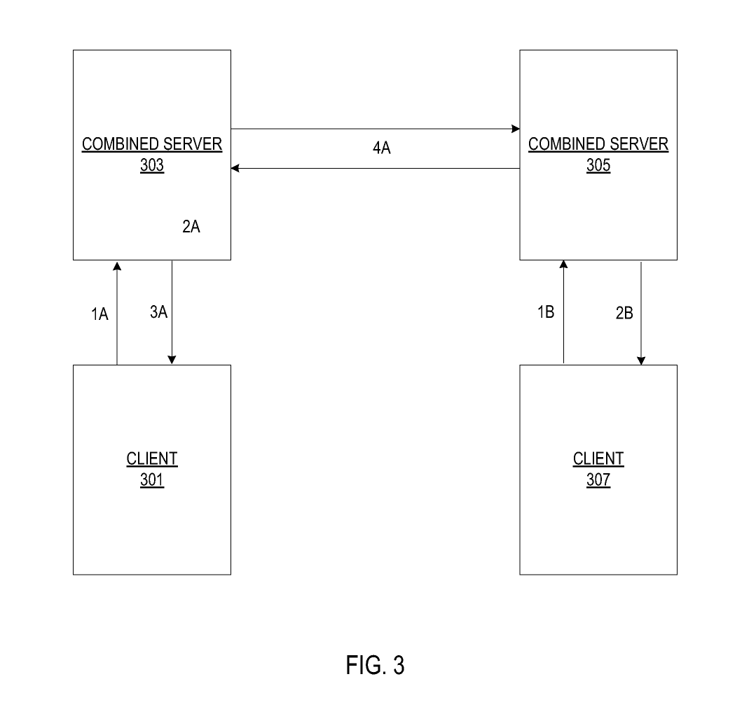

FIG. 3 is a block diagram illustrating the processing of a communication request issued by a client 301 or 307, in accordance with some embodiments of the present invention.

If the client request is an asynchronous communication request, such as a create job request issued by client 301, it would typically have to be processed by a separate event services server before it could be executed by a separate application server. In embodiments of the present invention, however, a create job request issued by client 301 is either processed by a single combined server or redirected by the combined server to another combined server to more evenly balance the load between the two servers.

Referring to FIG. 3, when client 301 issues a create job request, the request is load balanced (step 1A) to one of the combined servers 303 or 305 as described in conjunction with FIG. 2. The combined server to which the request is sent converts the create job message into an execute task call locally (step 2A), and notifies client 301 (step 3A) that the create job request has been completed. The execute task call is then load balanced between combined servers 303 and 305 and a determination is made as whether to execute the task locally or send it to the other combined server (step 4A), as described in conjunction with FIG. 2. Once the task has been executed, the combined server notifies the server that originated the call that the created job has been completed.

If the client request is not an asynchronous communication request, the client 307 issues the request (e.g. an execute script call). The request is load balanced to one of the combined servers 303 or 305 (step 1B) as described above in conjunction with FIG. 2. The combined server executes the requested script and returns a message or reply to the client once the task has been executed (step 2B).

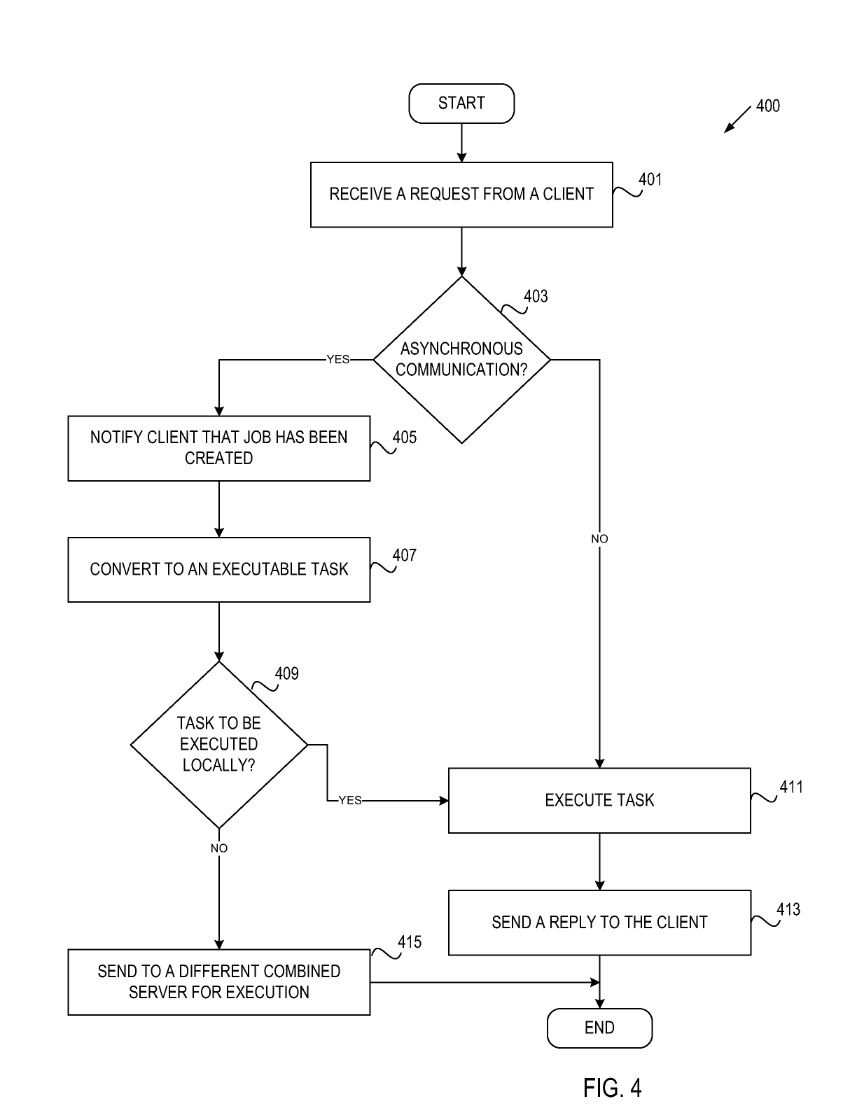

FIG. 4 illustrates one embodiment of a method 400 for processing and executing a client request by a combined server having event services and application server functionality. Method 400 can be performed by processing logic that can comprise hardware (e.g., circuitry, dedicated logic, programmable logic, microcode, etc.), software (e.g., instructions run on a processing device), or a combination thereof. In one embodiment, method 400 is performed by a server such as a combined server 213 or 215 of FIG. 2.

Referring to FIG. 4, at block 401, method 400 receives a request from a client (e.g., client 201 or 207). The combined server (e.g., combined server 213 or 215) may receive the request, which may be a request to create an asynchronous job or a request to execute a synchronous script by a user-operated client. In other embodiments, the request may be an automated request sent by a manufacturing tool, or other request.

At block 403, method 400 determines whether the received communication (i.e., the request) is asynchronous. The combined server may determine whether the received communication is asynchronous by examining the request and comparing it to a list of known requests. If, at block 403, method 400 determines that the communication is asynchronous, such as a create job request, at block 405, the event services module (e.g., event services module 217 or 219) of the combined server notifies the client that the request was received and processed (e.g., that the asynchronous job has been created). At block 407, the event services module converts the request into an executable task. If at block 403, method 400 determines that the communication is not asynchronous, at block 411, method 400 transmits the request directly to a business logic module (e.g., business logic module 233, 235) for execution.

In one embodiment, an asynchronous communication request is converted into an executable task by the PDController service provided by the event services module. A request to execute the task is then created by the event services module of the combined server, and at block 409, method 400 makes a load balancing decision, deciding whether to execute the task locally by the business logic module of the local server or send it to another combined server for execution by the business logic module of the other server. In one embodiment, the load-balancing decision is made by a load balancer (e.g., load balancer 225 or 229) on the combined server and is based, at least in part, on the number of calls currently executing on each server, as described in conjunction with FIG. 2.

If at block 409, method 400 determines that the task should be executed locally (i.e., on the combined server on which the request to execute the task was created at block 407), at block 411, method 400 executes the task. The task may be executed by the business logic module on the local combined server. At block 413, method 400 generates a reply (or other message) informing the client that the task has been executed. If at block 409, method 400 determines that the task should be executed on another combined server, at block 415, method 400 sends the task to the appropriate combined server. The other combined server may then execute the task without making another load balancing decision.

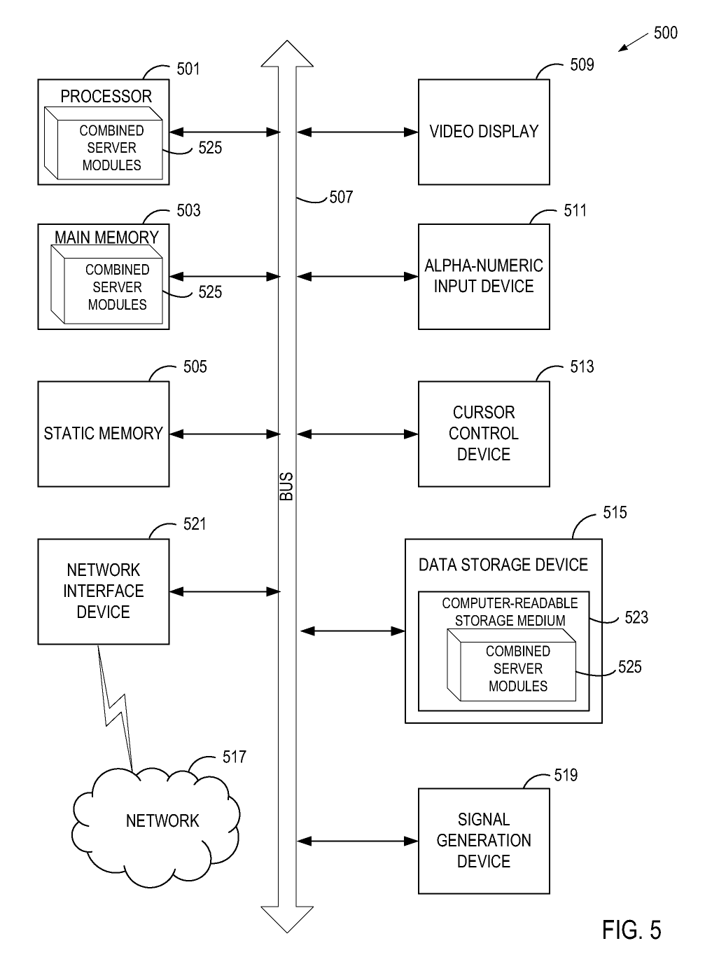

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 501, a main memory 503 (e.g., read-only memory (ROM), flash memory, dynamic random access memory (DRAM) such as synchronous DRAM (SDRAM), etc.), a static memory 505 (e.g., flash memory, static random access memory (SRAM), etc.), and a secondary memory 515 (e.g., a data storage device), which communicate with each other via a bus 507.

The processor 501 represents one or more general-purpose processing devices such as a microprocessor, central processing unit, or the like. More particularly, the processor 501 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 501 may also be one or more special-purpose processing devices such as an application specific integrated circuit (ASIC), a field programmable gate array (FPGA), a digital signal processor (DSP), network processor, or the like. The processor 501 is configured to execute processing logic of combined server modules 525 (which may represent combined server modules 213 and 215) for performing the operations and steps discussed herein.

The computer system 500 may further include a network interface device 521. The computer system 500 also may include a video display unit 509 (e.g., a liquid crystal display (LCD) or a cathode ray tube (CRT)), an alphanumeric input device 511 (e.g., a keyboard), a cursor control device 513 (e.g., a mouse), and a signal generation device 519 (e.g., a speaker).

The secondary memory 515 may include a machine-readable storage medium (or more specifically a computer-readable storage medium) 523 on which is stored one or more sets of instructions (e.g., of combined server modules 525) embodying any one or more of the methodologies or functions described herein. The combined server modules 525 may also reside, completely or at least partially, within the main memory 503 and/or within the processing device 501 during execution thereof by the computer system 500, the main memory 503 and the processing device 501 also constituting machine-readable storage media. The combined server modules 525 may further be transmitted or received over a network 517 via the network interface device 521.

The machine-readable storage medium 523 may also be used to store the combined server modules 213 and 215 of FIG. 2. While the machine-readable storage medium 523 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine that cause the machine to perform any one or more of the methodologies of the present invention. The term “machine-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “storing”, “associating”, “facilitating”, “assigning”, “receiving”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method comprising:
receiving, by a combined server, a communication request from a client, the combined server providing event services and application server functionality;
determining if the received request corresponds to an asynchronous or a synchronous communication;
if the received request corresponds to an asynchronous communication, creating a task corresponding to the communication request;
determining whether to execute the task locally on the combined server or on a remote combined server; and
if the task is to be executed locally, executing the task.

2. The computer-implemented method of claim 1, further comprising:
if the task is to be executed on a remote combined server, sending the task to the remote combined server.

3. The computer-implemented method of claim 1, further comprising:
if the received request corresponds to a synchronous communication, determining whether to process the request locally on the combined server or on a remote combined server; and
if the request is to be processed locally, processing the request.

4. The computer-implemented method of claim 3, further comprising:
If the request is to be processed on a remote combined server, sending the request to the remote combined server.

5. The computer-implemented method of claim 1, wherein the asynchronous communication comprises a create job request.

6. The computer-implemented method of claim 1, wherein the synchronous communication comprises an execute script call.

7. A computer system comprising:
a processing device;
a memory coupled to the processing device, the memory storing modules configured to provide event services and application server functionality, the modules comprising:
an event services module configured to receive a communication request from a client, determine if the received request corresponds to an asynchronous or a synchronous communication, and if the received request corresponds to an asynchronous communication, create a task corresponding to the communication request;
a load balancer module configured to determine whether to execute the task locally on the combined server or on a remote combined server; and
a business logic module configured to execute the task, if the task is to be executed locally.

8. The computer system of claim 7, the modules further comprising:
an interceptor module configured to send the task to the remote combined server, if the task is to be executed on the remote combined server.

9. The computer system of claim 7, wherein the load balancer is configured to determine whether to process the request locally on the combined server or on a remote combined server, if the received request corresponds to a synchronous communication.

10. The computer system of claim 9, wherein the business logic module is configured to process the request, if the request is to be processed locally.

11. The computer system of claim 7, the modules further comprising:
a shared memory module configured to store information regarding an availability and a workload of the local and remote combined servers.

12. The computer system of claim 7, wherein the event services module is configured to notify the client that the task has been executed.

13. A non-transitory machine-readable storage medium storing instructions which, when executed, cause a data processing system to perform a method comprising:
receiving, by a combined server, a communication request from a client, the combined server providing event services and application server functionality;
determining if the received request corresponds to an asynchronous or a synchronous communication;
if the received request corresponds to an asynchronous communication, creating a task corresponding to the communication request;
determining whether to execute the task locally on the combined server or on a remote combined server; and
if the task is to be executed locally, executing the task.

14. The storage medium of claim 13, the method further comprising:
if the task is to be executed on a remote combined server, sending the task to the remote combined server.

15. The storage medium of claim 13, the method further comprising:
if the received request corresponds to a synchronous communication, determining whether to process the request locally on the combined server or on a remote combined server; and
if the request is to be processed locally, processing the request.

16. The storage medium of claim 15, the method further comprising:
if the request is to be processed on a remote combined server, sending the request to the remote combined server.

17. The storage medium of claim 13, the method further comprising:
notifying the client that the task has been executed.
